(19) United States
(12) Patent Application Publication
(10) Pub. No.: US 2005/0126706 A1
(43) Pub. Date: Jun. 16, 2005

(54) Non-corrosive low temperature liquid resist adhesive

(76) Inventors: Richard D. Bunch, San Jose, CA (US); Yun-Lin Hsiao, San Jose, CA (US); Dennis McKean, Milpitas, CA (US); Timothy Joseph Neumann, San Jose, CA (US); Li Zheng, Campbell, CA (US)

Correspondence Address: REED INTELLECTUAL PROPERTY LAW GROUP, 800 MENLO AVENUE, SUITE 210, MENLO PARK, CA, 94025, US

(21) Appl. No.: 10/734,008

(22) Filed: Dec. 10, 2003

(51) Int. Cl. C09J 1/00

(52) U.S. Cl. 156/325; 156/327

(57) ABSTRACT

Methods of improving the adhesive characteristics of an adhesive resin composition and the use of the adhesive for bonding substrate materials, such as ceramic materials and manufacturing tools, are described. The adhesive composition includes a resist adhesive resin and a solvent having a boiling point in the range of about 30° C. to about 80° C. The methods and the adhesive composition find utility in hard disk drive applications, such as in the manufacture of sliders for hard disk drives.

### FIELD OF THE INVENTION

This invention relates to the use of a resist adhesive composition in a method of making certain components for magnetic storage hard disc drives. More particularly, the invention relates to the addition of a solvent to a resist adhesive resin for use in bonding a ceramic material to a manufacturing tool.

### BACKGROUND OF THE INVENTION

A magnetic storage system typically includes one or more magnetic recording disks having surfaces from which data may be read and to which data may be written by a read/write transducer or “head.” Many rotating rigid disk drives include heads supported on a carrier (or “slider”) that rides on a cushion or bearing of air above the surface of a magnetic recording disk when the disk is rotating at operating speed. The slider has an air-bearing surface (“ABS”), typically in the form of a plurality of rails, and is connected to a linear or rotary actuator by means of a suspension. There may be a stack of disks in the disk drive with the actuator supporting a number of sliders. The actuator moves the sliders radially so that each head may access the recording area of its associated disk surface. The slider in the disk drive is biased toward the disk surface by a small force from the suspension. The ABS of the slider is thus in contact with the disk surface from the time the disk drive is turned on until the disk reaches a speed sufficient to cause the slider to ride on the air bearing. The ABS of the slider is again in contact with the disk surface when the disk drive is turned off and the rotational speed of the disk falls below that necessary to create the air bearing. This type of disk drive is called a contact start/stop (CSS) disk drive. To provide wear resistance for the ABS in a CSS disk drive, a protective carbon overcoat may be placed on the slider rails. U.S. Pat. No. 5,159,508 to Grill et al., describes a slider with air-bearing rails having an amorphous carbon overcoat that is adhered to the rails by a silicon adhesion layer.

The magnetic recording disk in a CSS rigid disk drive is typically a thin film disk comprising a substrate, such as a disk blank made of glass, ceramic, glassy carbon or an aluminum-magnesium alloy with a nickel-phosphorous surface coating, and a cobalt-based magnetic alloy film formed by sputter deposition over the substrate. A protective overcoat, such as a sputter-deposited amorphous carbon film, is formed over the magnetic layer to provide corrosion resistance and wear resistance from the ABS of the slider. The overcoat may further include relatively small amounts of embedded iron, tungsten or tungsten carbide to improve wear resistance and minimize the likelihood of damage to disk file components.

The manufacture of microelectronic devices, such as thin film magnetic heads or sliders, involves a number of complex operations and materials. As is generally known to the skilled artisan, at least some of these may include the use of resist resins and/or adhesives. For example, in U.S. Pat. No. 5,932,113 (Kurdi et al.) a number of methods are described for preparing thin magnetic films, such as the surface of a slider, for etch patterning. The method of Kurdi et al. generally involves the application of an adhesive to the ABS side of such thin films, which may comprise a transducer-laden air-bearing surface. Also, in U.S. Pat. No. 5,057,184 (Gupta et al.), a thin layer of paraffin or a resist resin is applied to a slider to provide temporary corrosion protection.

The use of novolac resins in the manufacture of microelectronic devices, both as resist resins and as coating or protective layers for such devices, has also been described. In U.S. Pat. No. 5,939,134 (McKean et al.), for example, photoresists such as novolacs are described for use in a method of making a thin film magnetic head. In U.S. Pat. No. 6,629,357 (Akoh), a thermosetting novolac resist resin is applied to the ABS of a slider followed by baking of the resist and dry etching of the ABS to form the peripheral part of the slider to a rounded tapered shape. A novolac polymer planarization film, formed from a coating solution and optionally containing a solvent, is further described in U.S. Patent Publication No. U.S. 2003/0130482 (Hacker et al.), published Jul. 10, 2003 and in related U.S. Pat. No. 6,506,831 (Hacker et al.).

Certain problems remain in the manufacture of microelectronic devices, however, requiring continued development of improvements in both the processing and materials utilized. For example, in the manufacture of sliders, the substantial number of mechanical and chemical processing steps used to form sliders results in higher costs and reduced overall yields. Reducing the number of processing operations and improving the production by reducing the need for certain operations, such as grinding, while also reducing or eliminating adverse processing effects, such as corrosion and thermal distortion, are therefore important manufacturing objectives.

As such, despite the advances in technology, there remains a continuing need to develop improved methods of making microelectronic devices such as sliders for HDD applications. The present invention addresses such needs in part by providing an improved adhesive composition that, in one embodiment, is suitable for bonding ceramic materials to other materials. Such adhesive compositions may be used, e.g., to facilitate the manufacturing of sliders for hard disk drive applications.

### SUMMARY OF THE INVENTION

One aspect of the invention relates to a method of bonding a ceramic material to a manufacturing tool comprising
providing an adhesive composition comprising a resist adhesive resin and a solvent, wherein the solvent has a boiling point in the range of about 30° C. to about 80° C.;
placing the adhesive composition onto a surface of the ceramic material;
contacting the manufacturing tool with the adhesive composition on the surface of the ceramic material such that the tool and the ceramic material bond together; and
subjecting the adhesive composition located between the tool and the ceramic material to conditions effective to substantially remove the solvent from the adhesive.

Another aspect of the invention concerns an improvement in a method of manufacturing a slider for a hard disk drive, wherein an adhesive is used to bond a ceramic material to a manufacturing tool, the improvement which comprises employing an adhesive composition comprising a resist adhesive resin and a solvent, wherein the solvent has a boiling point in the range of about 30° C. to about 80° C.

In another aspect of the invention, a method is provided for improving the adhesive characteristics of an adhesive composition for use in bonding a ceramic material to a manufacturing tool comprising adding a solvent to a resist adhesive resin, wherein the solvent has a boiling point in the range of about 30° C. to about 80° C.

Yet another aspect of the invention relates to an adhesive resist composition comprising a resist adhesive resin and a solvent, wherein the solvent has a boiling point in the range of about 30° C. to about 80° C. The adhesive composition may be used in a variety of applications, including those associated with the manufacture of components for hard disc drives, such as in the manufacture of sliders for hard disk drive drives.

Additional aspects, advantages and novel features of the invention will be set forth in part in the detailed description that follows, and will become apparent to those skilled in the art upon examination of the following, or may be learned by practice of the invention through routine experimentation.

### BRIEF DESCRIPTION OF THE FIGURES

FIGS. 1A-1C, collectively referred to as FIG. 1, depict an example of the application of the inventive adhesive in a method of bonding a quad material to a manufacturing tool. FIG. 1A depicts the relationship of a quad as a section of a wafer material. FIG. 1B depicts a quad ceramic material adhesively bonded on the flex side of the quad to an extender manufacturing tool. FIG. 1C depicts a quad material adhesively bonded on the flex side of the quad to an extender manufacturing tool and having the inventive adhesive composition located on the air-bearing surface (ABS) side in preparation for bonding a slotted extender manufacturing tool to the ABS side of the quad.

FIGS. 2A-2D, collectively referred to as FIG. 2, depict an example of the post bond processing operations of a quad ceramic material in a method of bonding a quad ceramic material to a manufacturing tool to prepare sliders for hard disk drives. FIG. 2A depicts a quad bonded on the flex side to an extender tool and on the ABS side to a slotted extender tool. FIG. 2B depicts the quad during intermediate row slicing, grinding and lapping operations. FIG. 2C depicts the bonded quad row following row parting operations. FIG. 2D depicts the de-bonded ceramic material following row parting in which the adhesive is removed from the ceramic material.

FIG. 3 is a an optical microscope image of the liquid resist on a magnetic head showing complete coverage of the resist on the pole tips.

### DETAILED DESCRIPTION OF THE INVENTION

Definitions and Overview

The definitions set forth herein apply only to the terms as they are used in this patent and may not be applicable to the same terms as used elsewhere, for example in scientific literature or other patents or applications including other applications by these inventors or assigned to common owners. The following description of embodiments and examples are provided by way of explanation and illustration. As such, they are not to be viewed as limiting the scope of the invention as defined by the claims. Additionally, when examples are provided, they are intended to be exemplary only and not to be restrictive. As well, when an example is said to “include” a specific feature, it is intended to imply that it may have that feature but not that such examples are limited to those that include such features.

As used in this specification and in the appended claims, the singular forms “a”, “an” and “the” include plural referents unless the context clearly dictates otherwise. Thus, for example, reference to “an adhesive” or “a solvent” includes a mixture of two or more adhesives or a mixture of two or more such solvents, and the like. Similarly, the phrase “a combination thereof” includes mixtures of one or more of the same category of referent, as well as mixtures of different referents. More particularly, the combination of a resin and a solvent is intended to include mixtures of one or more resins with one or more solvents, in addition to a mixture of one resin and one solvent.

In describing and claiming the present invention, the following terminology is used in accordance with the definitions set out below.

As used herein, the term “quad” refers generally to a rectangular section of a ceramic material, such as a wafer, which is to be further sliced into a number of rows, and the rows further parted into individual components, e.g., sliders for use in hard disk drives. A typical quad may contain 39 rows, with each row capable of being parted into 44 sliders.

The terms “extender” and “slotted extender” refer to manufacturing tools attached to a ceramic material, such as a quad, to allow further mechanical processing, such as grinding, cutting and lapping operations.

The phrase “substantially remove the solvent from the adhesive” is generally intended to mean that most or all of the solvent is removed from the adhesive. Minor residual amounts not adversely affecting the bonding of the adhesive composition to the particular bonded substrates may still remain.

The phrase “placing the adhesive composition” is intended to mean, without limitation, that any suitable method or means of applying the adhesive composition on the substrate may be utilized. Such methods may include, e.g., conventional means, such as spray or dip coating or by dispensing the adhesive from an applicator, such as a syringe.

The term “bond” is used herein in its ordinary sense and means to join securely. Typically, but not necessarily, “bonding” is achieved through adhesive forces. Similarly, the term “debondable” as in “debondable adhesive” refers to an adhesive that is capable of being completely removed from the surfaces of substrates bonded thereby without damage to the substrates.

Resist Adhesive Resins

A number of resists are known in the art and are useful as adhesives or as a component of adhesive compositions suitable for use in the present invention. In general, the resist should function as a suitable adhesive resin for bonding at least two substrate materials together, such as a ceramic material and a tool material used in the manufacture of components for hard disk drives. In combination with one or more solvents, the resist adhesive resin is selected to provide an adhesive composition with good bonding to both bonded substrates, e.g., a ceramic material and a manufacturing tool. The resist is preferably be selected to provide an adhesive composition that is non-corrosive, especially to sensitive ceramic materials and surfaces, creates little or no thermal distortion when used to bond a ceramic material to another substrate, is easy and cost effective to prepare and use, allows the adhesive to function as a sealant to protect sensitive electronic components from exposure to corrosive environments, and is debondable from the substrates leaving no contamination on the substrate. In addition, where appropriate, the resist is preferably selected to provide other desirable characteristics to the adhesive composition including compatibility with aqueous grinding and lapping chemicals, compatibility with oil lapping chemicals, and transparency so that post processing inspection may be easily conducted.

Novolac resins are particularly suitable resist adhesive resins in accordance with the invention since they satisfy the objectives noted above for bonding a ceramic material to a manufacturing tool, such as in a method of making sliders. A variety of novolac polymers and formulations are commercially available or may be derived by reacting phenols or derivatives thereof with formaldehyde or other aldehyde compounds. Cresols, such as ortho-, meta- and para-cresol, are suitable phenolic compounds for forming novolacs. In general, mixtures of meta- and para-cresol are used instead of phenol for the production of resist grade novolacs, and are suitable for use in the present invention.

Although novolac resists are well-known in the art, such resists typically contain high boiling point solvents such as ethyl lactate, butyl acetate, and the like, which are not necessary in, and are desirably excluded from, the adhesive composition. Additional components of such commercial resists may include photoinitiators, such as 4-sulfonate diazonaphthoquinone (4DNQ) and other components not required in the adhesive composition.

The molecular weight of novolacs used for resists and suitable for use as an adhesive resin component of the composition are relatively small, with number average molecular weights (Mn) generally between 1000 and 3000. Weight average molecular weights (Mw) may generally be as large as 20,000. Novolacs having other molecular weights may be used, however, in part depending on selection of a solvent and the relative amounts of the novolac resin and the solvent in the adhesive composition.

Suitable novolac resins are available from commercial suppliers, such as Borden Chemical and Schenectady International. Other polymers can be substituted for the novolac materials described herein. Key attributes of such polymers are the incorporation of polar functionality such as hydroxyl groups, carboxylic acids or amino functionality to provide adequate adhesion to metallic and ceramic surfaces. Glass transition temperatures in excess of 60° C. are preferred to provide sufficient bond strength. Low molecular weight material is also preferred so that a polymer solution can be obtained in which the polymer content is greater than 50% by weight. The polymer should be capable of being purified to remove any source of ionic contamination that might cause corrosion of sensitive metallurgy on the substrate. Additional examples of suitable polymers include poly(ethylene-co-vinylalcohol), poly(2-hydroxyethylmethacrylate) and cellulose derivatives such as cellulose acetate or hydroxypropylcellulose. Still further suitable polymers are known to those skilled in the art.

Solvents

In general, solvents useful as a component of the adhesive compositions and methods of the invention include those solvents that, in conjunction with a particular resist adhesive resin, provide an adhesive composition achieving the objectives of the invention. For example, where the adhesive is utilized to bond a ceramic material to a manufacturing tool for further processing, the solvent is generally selected in conjunction with one or more resins such that the solvent may be readily removed to allow the resin(s) to develop full bonding strength, and thereby allow for further processing operations. Without limitation, the solvent is preferably non-corrosive, is easy, cost effective and safe to use, and allows the adhesive to function as a sealant to protect sensitive electronic components from exposure to corrosive environments.

In one embodiment, the solvent is capable of being readily removed from the adhesive composition after two substrates are bonded together, such as in the bonding of a ceramic material to a manufacturing tool, by subjecting the adhesive located between the tool and the ceramic material to conditions effective to substantially remove the solvent from the adhesive. For example, such conditions may include the use of vacuum conditions to aid in the evaporation of the solvent. Heat may also be used, such as by warming the adhesive in conjunction with the use of vacuum conditions, provided the adhesive bond between the substrates is not adversely affected by the increased temperature and that adverse thermal distortion problems between the substrates and the adhesive are not thereby encountered.

The solvent useful as a component of the adhesive compositions and in the methods of the invention generally has a boiling point in the range of about 30° C. to about 80° C., preferably from about 30° C. to about 70° C. Such solvents may be selected from aliphatic and aromatic hydrocarbons, alcohols, ethers, ketones, esters, alcohol esters, ether alcohols, ether esters, ketone alcohols, ketone ethers, ketone esters, amides, nitrites, or a combination thereof.

Some examples of useful solvents include acetone, isopropyl alcohol (IPA), dichloromethane, chloroform, tetrahydrofuran, ethyl acetate, methylethylketone or a combination thereof. Acetone is a preferred solvent.

Additional specific solvents suitable for use in the invention can be readily determined by persons skilled in the art without undue experimentation once they are aware of the present disclosure.

In an alternate embodiment, the adhesive composition does not include solvents having boiling points above about 80° C. For example, solvents such as ethyl lactate, butyl acetate, and the like, typically present in conventional resist formulations, have boiling points well in excess of 80° C. and are preferably excluded from the adhesive composition.

Adhesive Compositions

Adhesive compositions according to the invention are comprised of one or more resist adhesive resins and one or more solvents therefor, wherein the boiling point of the solvent is in the range of about 30° C. to about 80° C., preferably from about 30° C. to about 70° C.

In general, any suitable amount of resin and solvent may be used in the adhesive composition, provided the objectives of the invention are met. Typical amounts of the resist adhesive resin in the adhesive composition are in the range of about 35 wt. % to about 80 wt. %, preferably about 40 wt. % to about 70 wt. % and more preferably about 55 wt. % to about 65 wt. %. The corresponding total amount of solvent is typically in the range of about 20 wt. % to about 65 wt. %, preferably about 30 wt. % to about 60 wt. % and more preferably about 35 wt. % to about 45 wt. %.

Other conventional adhesive or novolac resist components may also be present, if desired, provided such components do not adversely affect the adhesive characteristics for the particular substrates that are to be bonded, or introduce other undesired effects. For example, where the adhesive composition is to be used to bond a ceramic material to a manufacturing tool, any additional components present in the adhesive should not be corrosive (e.g., of the pole tips of a magnetic head) and should not adversely affect the debonding of the adhesive from the ceramic material when desired.

Methods of Use

In general, the inventive adhesive composition and method may be used to bond a variety of substrates together. For example, in one embodiment, the adhesive composition may be placed on a ceramic material, such as a quad ceramic material used to form sliders for hard disk drives, so that a manufacturing tool can be bonded to the quad. Following bonding of the quad to the tool, additional mechanical and chemical operations may be carried out on the ceramic material to form microelectronic components, such as for hard disk drive applications. For example, in the case where sliders are to be prepared from a ceramic material, the bonded quad is subjected to various grinding, cutting, lapping and row parting operations to form the sliders. Once such operations are completed, the ceramic material is typically debonded from the tool by dissolving the inventive adhesive composition in a solvent.

Suitable ceramic substrate materials are not intended to be particularly limited, although generally suitable ceramic substrates include those useful for making microelectronic devices such as sliders. Exemplary ceramics materials are Al₂O₃— TiC ceramic, ferrites, titanium carbide, silicon carbide, silicon or silicon oxide/silicon materials, or a combination thereof.

The particular material of the manufacturing tool is also not particularly limited and may be selected from thermoplastic or thermoset polymer, metal, ceramic, glass, or a combination thereof.

The adhesive compositions can be applied by various known coating techniques such as spinning, spraying, dipping, film laminating, passing the substrate through a bath of the composition or by dispensing the composition onto the substrate using an applicator, such as a syringe dispenser.

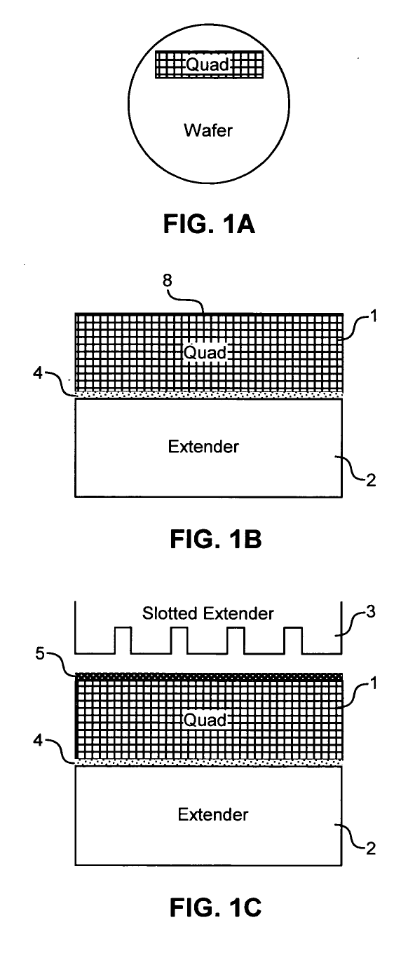

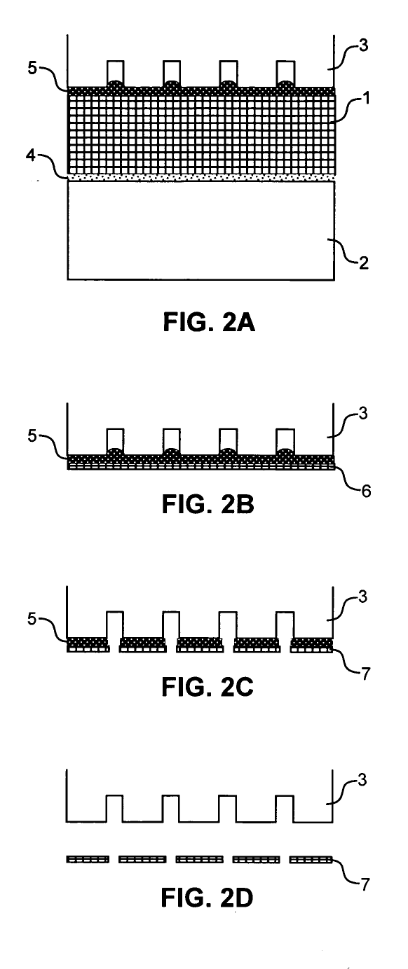

FIGS. 1 and 2 generally illustrate certain aspects of the method of the invention, as well as additional process operations for manufacturing sliders for hard disk drives.

In FIG. 1, one embodiment according to the invention for bonding a quad ceramic material to a manufacturing tool is illustrated. In FIGS. 1A and 1B, a section of a wafer, i.e. a quad 1, is shown as being bonded to an extender tool 2 on the flex side of the quad with an adhesive 4 that provides high bond strength and no thermal distortion. The air-bearing surface (ABS) 8 is shown on the opposite side from the flex side of the quad. In FIG. 1C, the inventive adhesive composition 5 has been applied to the ABS side of the quad in preparation for the bonding of the quad to a slotted extender manufacturing tool 3.

FIG. 2 illustrates the post bond operations for processing a quad ceramic material bonded to a manufacturing tool. In FIG. 2A, the quad 1 is shown as being bonded to an extender 2 using a high strength adhesive 4 and to a slotted extender 3 using the inventive adhesive composition 5. In FIG. 2B, the quad has been subjected to slicing, grinding and lapping operations, as known to the one skilled in the art, such that a row 6 of the quad remains bonded to the slotted extender 3. In FIG. 2C, the row has been subjected to a row parting operation to provide sliders 7 for hard disk drives. In FIG. 2D, the sliders 7 have been debonded from the slotted extender 3.

### EXAMPLES

The following examples are included so as to provide those of ordinary skill in the art with a complete disclosure and description of how to make and use the compositions and methods of the invention. Efforts have been made to ensure accuracy with respect to numbers (e.g., amounts, temperature, etc.) but some experimental error and deviations should, of course, be allowed for. Unless indicated otherwise, proportions are percent by weight, temperature is measured in degrees centigrade and pressure is at or near atmospheric. All components were obtained from commercially-available sources unless otherwise indicated.

### Example 1

An adhesive composition was prepared by mixing about 60% by weight of a novolac resin (available under the trade designation Durite® PD-444A from Borden Chemical Inc. Louisville, Ky.), about 40% by weight of acetone (available from Ultra Pure Solutions Inc., semiconductor grade, Castroville, Calif.). After mixing to dissolve the novolac resin in the acetone, the solution was allowed to mix overnight with stirring at ambient room temperature.

The adhesive was subsequently dispensed onto the ABS side of a quad ceramic material through the use of a syringe dispenser and the quad bonded to a stainless steel slotted extender tool. The bonded quad was then placed in vacuum box at about −28 in. Hg for about 40 minutes to extract the acetone. Following extraction, the novolac adhesive was sufficiently hardened to allow row slicing of the bonded quad.

After bonding the quad to the slotted extender, row slicing of the bonded quad was performed and the distribution of stripe heights obtained from post row slice and lapping was determined. During ABS lapping the resistance was continuously monitored in order to stop lapping at the desired final resistance. A dynamic algorithm was used to guarantee the maximum number of sliders remain within specification when the final resistance target was achieved.

Results of these measurements show that the distribution of stripe heights, indicated as the 3σ stripe height distribution, was 0.054 μm. The adhesive composition of Example 1 was run for over 1000 rows and all had 100% yield.

The inventive adhesive also demonstrated a high level of debondability of the adhesive from the quad following row slicing with a high level of cleanliness.

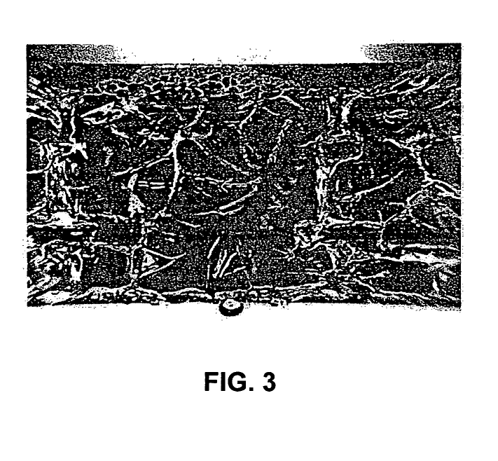

Visual observations of the coating characteristics of the adhesive composition were also performed. For example, FIG. 3 is an optical microscope image of the adhesive composition on a magnetic head showing complete coverage of the adhesive on the pole tips.

### Example 2

For the purposes of comparison, two other adhesives, a cyanoacrylate and a traditional resist, were used to bond a quad ceramic material to a stainless steel slotted extender tool according to the same general procedures of Example 1. The cyanoacrylate (available under the trade designation Loctite-498® Instant Adhesive from Loctite (Rocky Hill, Conn.) was allowed to cure at room temperature without subjecting the adhesive to a vacuum environment. The traditional resist was a cresol-formaldehyde resin composition containing ethyl lactate, butyl acetate and a photosensitizer. A vacuum oven cure at 100° C. for 60 minutes was used to cure the resist.

As in Example 1, after bonding the quad to the slotted extender, row slicing of the bonded quad was performed and the distributions of stripe heights obtained from row slicing for each of the cyanoacrylate and the traditional resist.

Results of these measurements show that the distribution of stripe heights, indicated as the 3σ stripe height distribution, was 0.055 μm for the cyanoacrylate adhesive and 0.660 μm for the traditional resist. The traditional resist (data from 42 rows) showed a 75% loss in yield as measured by 3σ stripe height and was discontinued. The cyanoacrylate was run for over 1000 rows and all had 100% yield.

An evaluation of the debondability and cleanliness of the cyanoacrylate and traditional resist was also conducted according to Example 1. The results for the cyanoacrylate and the traditional resist are summarized in Table 1 along with the results for the adhesive composition of Example 1.

TABLE 1
Comparison of Adhesive Compositions

| | Adhesive Composition | | |
|---|---|---|---|
| | Cyanoacrylate | Traditional Resist | Example 1 |
| Composition | Loctite | Cresol- | Cresol- |
| | adhesive | formaldehyde | formaldehyde |
| | (high chloride | resin | resin |
| | content) | Ethyl lactate | Acetone |
| | | (bp 154° C.) | (bp 54° C.) |
| | | Butyl lactate | |
| | | (bp 125° C.) | |
| | | Photosensitizer | |
| Bond & Cure | Room temp. | Oven bake | Extract solvent |
| conditions | | | in vacuum |
| 3 sigma stripe | 0.055 μm | 0.660 μm | 0.054 μm |
| height | | | |
| Debondability | Medium | High | High |
| Cleanliness | Contaminated | Clean | Clean |

As shown in Table 1, the inventive adhesive composition demonstrated an improved combination of properties compared against the cyanoacrylate adhesive and a traditional novolac resist. In particular, the inventive adhesive provides a significantly improved stripe height distribution, while maintaining high levels of debondability and cleanliness, compared with the traditional resist. As compared with the cyanoacrylate, the debondability and cleanliness of the adhesive composition is also improved thereover.

All patents, publications, and other published documents mentioned or referred to herein are incorporated by reference in their entireties.

It is to be understood that while the invention has been described in conjunction with the certain specific embodiments thereof, that the foregoing description as well as the examples, are intended to illustrate and not limit the scope of the invention. It should be further understood by those skilled in the art that various changes may be made and equivalents may be substituted without departing from the scope of the invention, and further that other aspects, advantages and modifications will be apparent to those skilled in the art to which the invention pertains.

1. A method of bonding a ceramic material to a manufacturing tool comprising
providing an adhesive composition comprising a resist adhesive resin and a solvent, wherein the solvent has a boiling point in the range of about 30° C. to about 80° C.;
placing the adhesive composition onto a surface of the ceramic material;
contacting the manufacturing tool with the adhesive composition on the surface of the ceramic material such that the tool and the ceramic material bond together; and
subjecting the adhesive composition located between the tool and the ceramic material to conditions effective to substantially remove the solvent from the adhesive.

2. The method according to claim 1, wherein the resist adhesive resin is present in an amount of about 30 wt. % to about 80 wt. %.

3. The method according to claim 1, wherein the resist adhesive resin is present in an amount of about 40 wt. % to about 70 wt. %.

4. The method according to claim 1, wherein the resist adhesive resin is present in an amount of about 55 wt. % to about 65 wt. %.

5. The method according to claim 1, wherein the adhesive composition excludes solvents having boiling points above about 80° C.

6. The method according to claim 1, wherein the resist adhesive resin is selected from novolac resins, poly(ethylene-co-vinylalcohol), poly(2-hydroxyethylmethacrylate), cellulose polymers, or a combination thereof.

7. The method according to claim 6, wherein the resist adhesive resin is a novolac resin.

8. The method according to claim 1, wherein the solvent is selected from aliphatic and aromatic hydrocarbons, alcohols, ethers, ketones, esters, alcohol esters, ether alcohols, ether esters, ketone alcohols, ketone ethers, ketone esters, amides, nitrites, or a combination thereof.

9. The method according to claim 8, wherein the solvent is selected from acetone, isopropyl alcohol, dichloromethane, chloroform, tetrahydrofuran, ethyl acetate, methylethylketone or a combination thereof.

10. The method according to claim 9, wherein the solvent is acetone.

11. The method according to claim 1, wherein the conditions effective to remove the solvent from the adhesive comprise subjecting the adhesive to vacuum conditions.

12. The method according to claim 1, wherein the ceramic material is used to form sliders for hard disk drive applications.

13. The method according to claim 1, wherein the manufacturing tool is formed from a material selected from thermoplastic or thermoset polymer, metal, ceramic, glass, or a combination thereof.

14. The method according to claim 12, wherein the adhesive composition is placed on the air-bearing surface side of said ceramic material.

15. In a method of manufacturing a slider for a hard disk drive, wherein an adhesive is used to bond a ceramic material to a manufacturing tool, the improvement which comprises employing an adhesive composition comprising a resist adhesive resin and a solvent, wherein the solvent has a boiling point in the range of about 30° C. to about 80° C.

16. The method according to claim 15, wherein the resin is a novolac resin.

17. The method according to claim 15, wherein the solvent is selected from acetone, isopropyl alcohol, dichloromethane, chloroform, tetrahydrofuran, ethyl acetate, methylethylketone or a combination thereof.

18. The method according to claim 15, wherein the solvent is acetone.

19. A method of improving the adhesive characteristics of an adhesive composition for use in bonding a ceramic material to a manufacturing tool comprising adding a solvent to a resist adhesive resin, wherein the solvent has a boiling point in the range of about 30° C. to about 80° C.

20. The method according to claim 19, wherein the resist adhesive resin is present in an amount of about 30 wt. % to about 80 wt. %.

21. The method according to claim 19, wherein the adhesive composition excludes solvents having boiling points above about 80° C.

22. The method according to claim 19, wherein the resin is selected from novolac resins, poly(ethylene-co-vinylalcohol), poly(2-hydroxyethylmethacrylate), cellulose polymers, or a combination thereof.

23. The method according to claim 23, wherein the resin is a novolac resin.

24. The method according to claim 19, wherein the solvent is selected from aliphatic and aromatic hydrocarbons, alcohols, ethers, ketones, esters, alcohol esters, ether alcohols, ether esters, ketone alcohols, ketone ethers, ketone esters, amides, nitrites, or a combination thereof.

25. The method according to claim 24, wherein the solvent is selected from acetone, isopropyl alcohol, dichloromethane, chloroform, tetrahydrofuran, ethyl acetate, methylethylketone or a combination thereof.

26. The method according to claim 25, wherein the solvent is acetone.

27. An adhesive composition for use in the manufacture of sliders for hard disk drive applications, comprising a resist adhesive resin and a solvent, wherein the solvent has a boiling point in the range of about 30° C. to about 80° C.

28. The adhesive composition according to claim 27, wherein the resin is selected from novolac resins, poly(ethylene-co-vinylalcohol), poly(2-hydroxyethylmethacrylate), cellulose polymers, or a combination thereof.

29. The adhesive composition according to claim 28, wherein the resin is a novolac resin.

30. The adhesive composition according to claim 27, wherein the solvent is selected from aliphatic and aromatic hydrocarbons, alcohols, ethers, ketones, esters, alcohol esters, ether alcohols, ether esters, ketone alcohols, ketone ethers, ketone esters, amides, nitrites, or a combination thereof.

31. The method according to claim 30, wherein the solvent is selected from acetone, isopropyl alcohol, dichloromethane, chloroform, tetrahydrofuran, ethyl acetate, methylethylketone or a combination thereof.

32. The adhesive composition according to claim 30, wherein the solvent is acetone.

33. The adhesive composition according to claim 27, wherein the solvent has a boiling point in the range of about 30° C. to about 70° C.

34. The adhesive composition according to claim 27, wherein the adhesive composition excludes solvents having boiling points above about 80° C.
